(19) United States
(12) Patent Application Publication
(10) Pub. No.: US 2026/0042622 A1
(43) Pub. Date: Feb. 12, 2026

(54) DEPOSITING TABLE

(71) Applicant: NEWTEC BAG PALLETIZING, Illzach Cedex (FR)

(72) Inventor: Frédéric HOLDER, Meyenheim (FR)

(21) Appl. No.: 19/099,927

(22) PCT Filed: Jul. 26, 2023
(86) PCT No.: PCT/EP2023/070698

§ 371 Date: Jan. 30, 2025

(30) Foreign Application Priority Data
Aug. 2, 2022 (DE) 10 2022 119 392.6

(51) Int. Cl. B65G 57/24

(52) U.S. Cl. CPC B65G 57/24

(57) ABSTRACT

A depositing table including a depositing device, a displacing device and an air feeding device, the depositing device is moveable by the displacing device between a closed position and an open position and an upper side of the depositing device includes a depositing surface receiving a sack layer. The depositing device is air flowable, an air feeding opening is on a lower side of the depositing device and the depositing surface has an air discharging opening. The air feeding device has an air guiding element with an air outlet opening and a connecting device, the connecting device is arranged between the air outlet opening and the air feeding opening. The connecting device creates a coplanar length compensation between the air outlet opening and the air feeding opening when the depositing device is moved. A palletizing device includes a conveying device with a conveying element and the depositing table.

The present invention relates to a depositing table, in particular for a palletizing device for palletizing sacks. Depending on the configuration, at least one sack layer can be formed on such a depositing table and can then be pushed off onto a pallet or the like. For this purpose, the depositing table comprises at least one depositing device, at least one displacing device and at least one air feeding device, wherein the depositing device is formed such that it can be moved by means of the displacing device at least between a closed position and an open position. An upper side of the depositing device comprises at least one depositing surface for receiving at least one sack layer, wherein the depositing device is formed such that it can be flown through by air at least in sections. For this purpose, at least one air feeding opening is provided on a lower side of the depositing device, and the depositing surface has at least one air discharging opening, wherein the air feeding device comprises at least one air guiding element with at least one air outlet opening and at least one connecting device. The connecting device is arranged between the air outlet opening of the air guiding element and the air feeding opening of the depositing device thereby. The present invention additionally relates to a palletizing device for palletizing piece goods, in particular of sacks or filled sacks, respectively, in particular of sacks filled with piece goods, comprising at least one conveying device with at least one conveying element for conveying piece goods and at least one such depositing table.

A so-called palletizing device is often connected downstream from, for example, packaging facilities for filling piece goods into sacks, which pelletizer stacks the filled sacks on pallets in certain sack layers. An optimal further transport of the filled sacks or also of other piece goods, depending on the facility, can thus be ensured.

In order to palletize filled sacks, a certain sack layer of a certain number of sacks in a certain arrangement to one another is arranged on a so-called depositing table and is subsequently deposited on a pallet located therebelow, e.g., by pulling away the depositing table.

So that the sacks do not deform when being pushed off and the push-off is simplified in general, an airflow between the depositing table and the sacks is generated in the case of known palletizing devices, depending on the configuration, in order to simplify the push-off or sliding, respectively, of the sacks from the bearing surface.

Depending on the configuration, air is introduced for this purpose into the depositing table, which is formed to be at least partly hollow, which air escapes through openings in the bearing surface and thus forms a type of air cushion below the sack layer.

To introduce the air into the depositing table, an air hose is provided in the case of known palletizing devices, which air hose is provided in the manner of a so-called monkey swing on the depositing table. When the depositing table is moved back and forth or when a sack layer is pushed off onto a palette, respectively, the necessary length difference and/or an angular offset is thus compensated.

It is disadvantageous in the case of such configurations, however, that a fairly large installation space is required due to the monkey swing. It must additionally be ensured that the hose does not collide with the conveying element, which conveys the sacks to the depositing table when moving back and forth. The operation of the palletizing device could be interrupted thereby or damages could also occur. The partly fairly large movement paths furthermore result in a relatively quick wear of the air hoses.

It is thus the object of the present invention to provide a depositing table, in the case of which the push-off of the sack layer is made simpler by means of a type of air cushion below the sacks, wherein the structurally necessary effort for this purpose requires as little space as possible, however, and a reliable operation is ensured.

This object is solved by means of a depositing table with the features of claim 1 and by means of a palletizing device with the features of claim 15. Preferred further developments of the invention are subject matter of the subclaims. Further advantages and features of the present inventions follow from the general description and the description of the exemplary embodiment.

The depositing table according to the invention can in particular be used for a palletizing device or in a palletizing device, respectively, for palletizing sacks, and comprises at least one depositing device, at least one displacing device and at least one air feeding device. The depositing device is thereby formed such that it can be moved by means of the displacing device at least between a closed position and an open position. An upper side of the depositing device furthermore comprises at least one depositing surface for receiving at least one sack layer, wherein the depositing device is formed such that it can be flown through by air at least in sections. At least one air feeding opening is provided on a lower side of the depositing device and the depositing surface has at least one air discharging opening. The air feeding device comprises at least one air guiding element with at least one air outlet opening and at least one connecting device, wherein the connecting device is arranged between the air outlet opening of the air guiding element and the air feeding opening of the depositing device. The connecting device is thereby suitable and formed to effect an essentially coplanar length compensation between the air outlet opening and the air feeding opening when the depositing device is moved.

The air feeding device can in particular produce a type of air cushion below the sacks arranged on the depositing device in order to reduce coefficients of friction, so that a deformation of sacks does not occur when pulling away or opening the depositing device, respectively.

For this purpose, the depositing table or the depositing device, respectively, is ventilated from within. In particular, no significant pressures are established thereby due to this ventilation. In particular, a simple blower can preferably be used.

In order to configure the depositing device such that it can be moved, the displacing device in particular comprises at least one rail system, on which the plate or the depositing device, respectively, can be moved, for example by means of a belt drive.

In particular, a plurality of air discharging openings are provided in the depositing device or in the surface, respectively, in order to provide air for producing an air cushion, in particular on a large portion of and in particular on the entire surface of the depositing table or of the depositing device, respectively.

In the closed position of the depositing device, at least one pallet can preferably be arranged below the depositing table or below the depositing device, respectively, onto which pallet the sack layer arranged on the depositing device is deposited or pushed off, respectively, when opening the depositing device.

The closed position or extended position, respectively, of the depositing device is thus the position, in which the pallet is covered below the depositing table. A sack layer rests on the depositing device in this position. The open position is therefore the position, in which the depositing device is retracted or moved back, respectively, so that the pallet below the depositing table is released in order to push the sacks onto the pallet.

The depositing table according to the invention provides many advantages. One significant advantage is that a type of air cushion for easily pushing off a sack layer can be provided in order to reduce the coefficient of friction, so that the sacks do not deform when being pushed off onto a pallet or the like.

Due to the configuration according to the invention, this is possible with a very flat construction, so that the remaining assembly space is not disturbed. Otherwise common air hoses are not required, which are otherwise provided in the manner of a so-called monkey swing, in order to be able to provide for longer movement paths. The longer movement paths otherwise often lead to a large wear and additionally to a collision, for example with the lower run of the conveying device, which conveys the sacks to the depositing table. In particular the depositing table can be moved between the upper and lower run of the conveying element in this way, which provides for a small transfer height from the conveying device onto the depositing table here. Depending on the configuration, a large height offset at this point leads to a deformation of the sacks during the transfer of the sacks and, as a result, to a worse stack pattern on the pallet.

The connecting device is preferably formed in a telescopable manner at least in sections. Telescopic or telescopable, respectively, is in particular understood in such a way thereby that a length compensation between air discharging opening and air feeding opening takes place when the depositing device is moved.

The air guiding element is preferably provided in a stationary manner. A secure and stable assembly of the air of the air guiding element can thus be attained and a configuration with a very flat construction can also be provided.

The connecting device is particularly preferably present essentially in a parallel plane to the depositing device. The connecting device is thereby in particular arranged essentially parallel to the depositing surface or to the lower side, which is present in parallel, respectively.

The connecting device is preferably formed in an essentially rigid manner, so that it in particular does not sag or is not provided in the manner of a so-called monkey swing, respectively.

In advantageous configurations, the connecting device is rotatably connected to the air discharging opening of the air guiding element and/or of the air feeding opening of the depositing device, in particular in each case by means of at least one pneumatic rotary feedthrough. It can thus be attained that a displacement of the depositing device is made possible in spite of the use of rigid components because the connection of the connecting device is configured in a rotatable manner and the connecting device as such is formed essentially in a telescopic manner.

In preferred further developments, the connecting device is arranged essentially transversely to the moving direction of the depositing device. The connecting device is thereby preferably arranged transversely or essentially transversely, respectively, to the moving direction of the depositing device at least in one position.

Alternatively, rotary feedthroughs can be forgone in expedient further developments when the connecting device is arranged in the longitudinal direction of the moving direction. Depending on the configuration, this then requires an increased stroke of the device with respect to the transverse orientation.

The air outlet opening of the air guiding element is preferably spaced apart essentially equally from the air feeding opening in the closed position and the open position of the depositing device.

The connecting device particularly preferably has an essentially maximum extension when the depositing device is present in the closed position and/or the open position.

In expedient further developments, the connecting device has an essentially minimum extension when the depositing device is present between the closed position and the open position, thus in particular in a middle position. It is in particular provided that, for example when using a telescopable pipe as connecting device, said pipe is present so as to be retracted in the middle position and is in each case extended or telescoped, respectively, to the end points or the open and the closed position, respectively. This minimizes the distance to be telescoped and thus reduces the wear.

The telescopable connecting device preferably comprises at least one pipe-in-pipe system. For example, a pipe-in-pipe system can thus be configured, for example, with 120 mm pipes or the like.

The pipes of the pipe-in-pipe system are preferably not connected to one another in an (absolutely) fluid-tight manner. It can in particular be provided thereby that an intentional leakage is provided or that no seals are used, respectively, so that dust or particles, respectively, which are present, are discharged by means of the leakage air. Such an airflow generated by means of the leakage simultaneously creates a wear-reducing air cushion.

In advantageous configurations, the telescopable connecting device has at least one bellows. A telescopable connecting device can also be provided by means of such a configuration in addition to a pipe-in-pipe system or also exclusively, provided that this bellows is embodied in a sufficiently stiff manner, so that it does not or not significantly sag. A bellows can preferably also be provided as protection.

The telescopable connecting device preferably comprises at least one carrier device, which is connected in an articulated manner. It is thus also possible, for example, to provide, for example, v-shaped struts as support for hoses. This v-shaped configuration then preferably lies in a plane parallel to the depositing device and folds apart towards the end layers, so that a telescopic connecting device is thus also provided.

In expedient further developments, at least one blower device is connected to at least one air inlet of the air guiding element. A sufficient airflow for generating the air cushion effect can preferably be provided via this blower device.

The palletizing device according to the invention for palletizing piece goods, in particular of sacks (in particular filled with piece goods), comprises at least one conveying device with at least one conveying element for conveying piece goods and at least one depositing table, as it has been described above.

The palletizing device according to the invention also comprises the advantages, as they have already been described above with regard to the depositing table according to the invention.

The depositing device of the depositing table can preferably be displaced at least in sections between upper run and lower run of the at least one conveying element of the conveying device. Due to the fact that the depositing device can be displaced between upper run and lower run, a configuration with a particularly flat construction can be realized.

In advantageous further developments, the connecting device is arranged at least in sections between the upper run and the lower run in a plane parallel to the upper run and/or the lower run. Due to the fact that the connecting device is also arranged between the upper run and the lower run of the conveying element, a configuration with a particularly flat construction can be attained, without resulting in a collision of components with conveying elements.

In expedient further developments, the air guiding element is arranged or can be arranged, respectively, at least in sections between the upper run and the lower run in a plane parallel to the upper run and/or the lower run. The same advantage as already described above also applies for this, namely that a configuration with a particularly flat construction is made possible.

Further advantages and features of the present invention follow from the exemplary embodiment, which will be explained below with reference to the enclosed figures.

In the Figures:

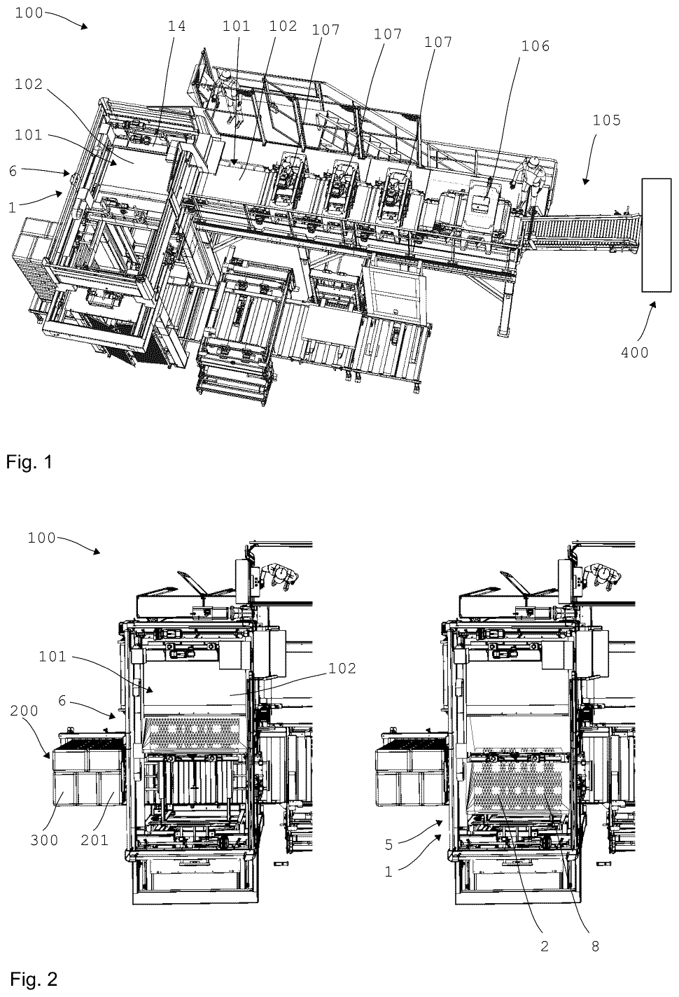

FIG. 1 shows a purely schematic illustration of an exemplary embodiment of a palletizing device according to the invention in a perspective view;

FIG. 2 shows two purely schematic illustrations of an exemplary embodiment of a depositing table of the palletizing device according to FIG. 1 in a view from the top with the depositing device in different positions;

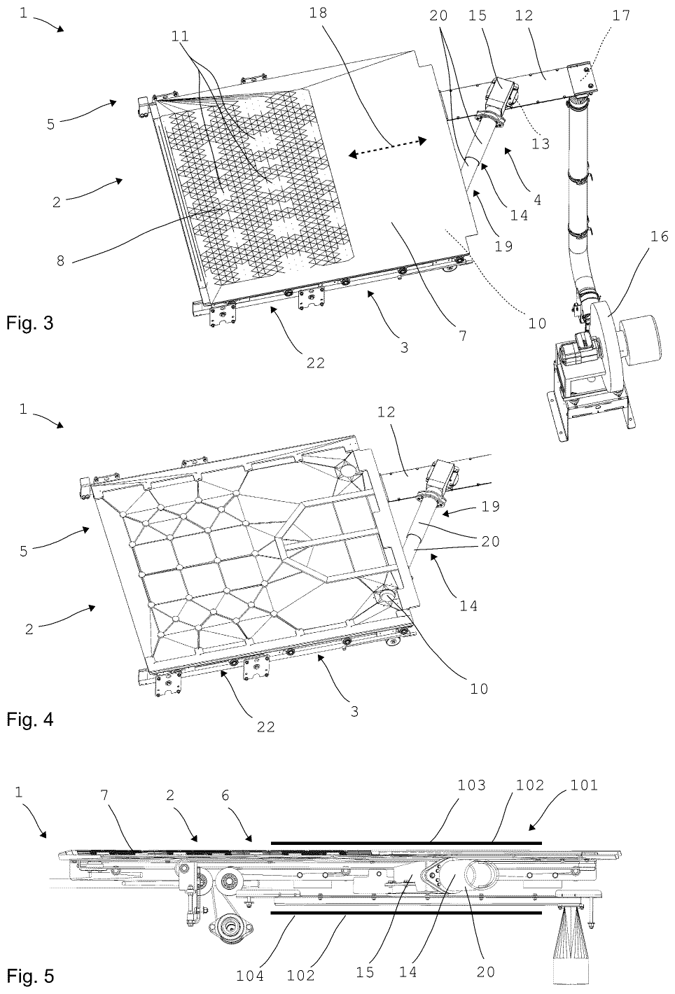

FIG. 3 shows a purely schematic illustration of an exemplary embodiment of a depositing table according to the invention in a perspective view from the top with the depositing device in the closed position;

FIG. 4 shows a purely schematic illustration of an exemplary embodiment of a depositing table according to the invention in a perspective view;

FIG. 5 shows a purely schematic illustration of an exemplary embodiment of a depositing table according to the invention in a sectional view from the side;

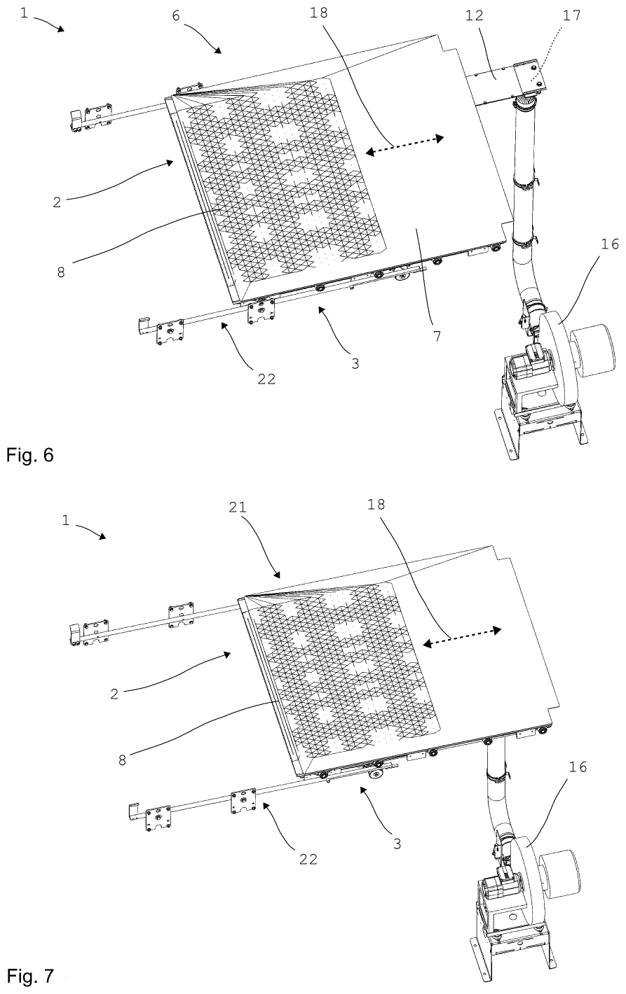

FIG. 6 shows a purely schematic illustration of an exemplary embodiment of a depositing tale according to the invention in a perspective view from the top with the depositing device in the middle position;

FIG. 7 shows a purely schematic illustration of an exemplary embodiment of a depositing table according to the invention in a perspective view from the top with the depositing device in the open position;

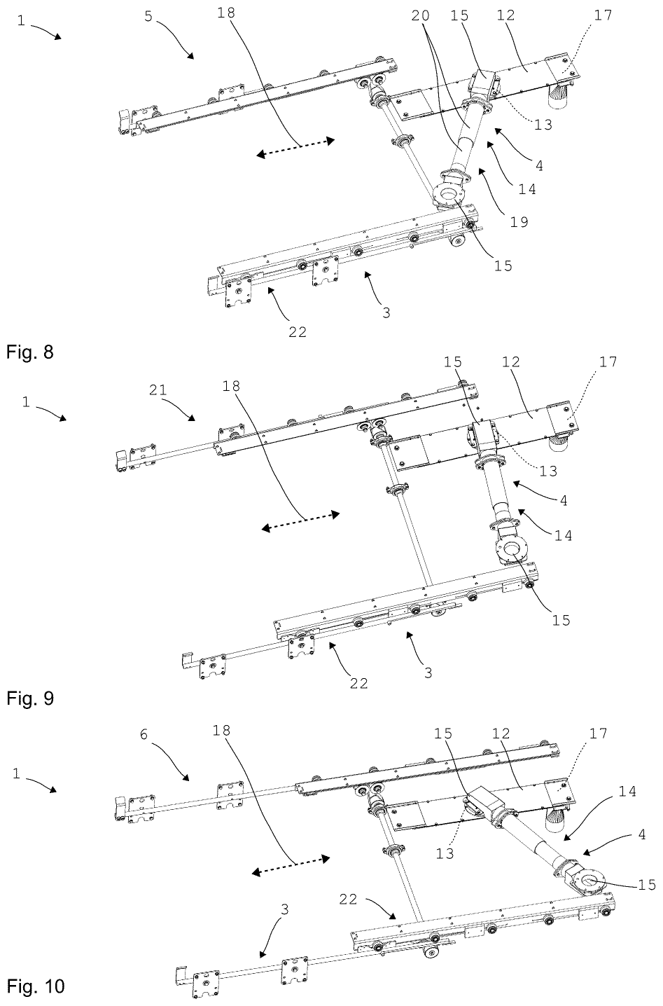

FIG. 8 shows a purely schematic illustration of an exemplary embodiment of a depositing table according to the invention without depositing device in a perspective view from the top with the depositing device in the closed position;

FIG. 9 shows a purely schematic illustration of an exemplary embodiment of a depositing table according to the invention without depositing device in a perspective view from the top with the depositing device in the middle position;

FIG. 10 shows a purely schematic illustration of an exemplary embodiment of a depositing table according to the invention without depositing device in a perspective view from the top with the depositing device in the open position;

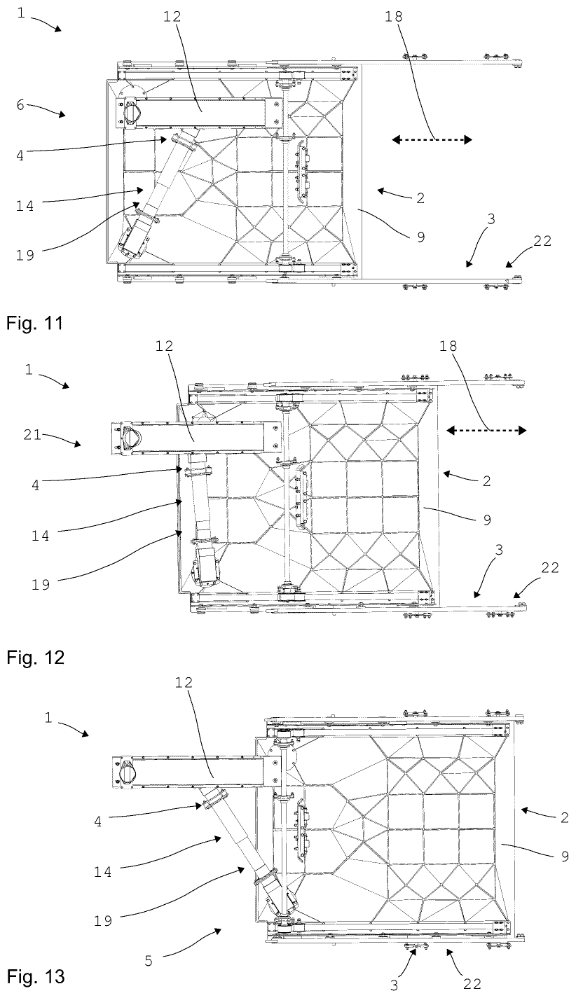

FIG. 11 shows a purely schematic illustration of an exemplary embodiment of a depositing table according to the invention without depositing device in a perspective view from the bottom with the depositing device in the open position;

FIG. 12 shows a purely schematic illustration of an exemplary embodiment of a depositing table according to the invention without depositing device in a perspective view from the bottom with the depositing device in the middle position; and

FIG. 13 shows a purely schematic illustration of an exemplary embodiment of a depositing table according to the invention without depositing device in a perspective view from the bottom with the depositing device in the closed position.

An exemplary embodiment of a palletizing device 100 according to the invention with a depositing table 1 according to the invention is illustrated purely schematically in a perspective view from the top in FIG. 1. The palletizing device 100 shown here is provided for arranging sacks 201 filled with piece goods in a predetermined layer pattern on pallets or to palletize the sacks, respectively. For this purpose, the palletizing device 100 comprises a sack infeed 105, which receives the sacks filled by a packaging facility 400, which is not illustrated in more detail.

A smoothing device 106, which adapts the height of the filled sacks 201 or of the piece goods 300 to be packaged, respectively, is arranged downstream from the sack infeed 105, so that a particularly good stackability of the sacks 201 is present.

In the shown exemplary embodiment, three gripping and rotating devices 107, which orient the sacks 201 to be stacked or piece goods 300 to be stacked, respectively, are arranged downstream from the smoothing device 106, so that a certain layer pattern with correspondingly oriented sacks 201 can be produced on the depositing table 1 or on an intermediate storing surface.

A conveying device 101 with a conveying element 102, which ends next to the depositing table 1 here, serves the purpose of conveying the sacks 201 or piece goods 300, respectively. The sacks 201 can then be pushed or conveyed, respectively, onto the depositing table 1 by means of the conveying element.

Two views onto the region of the palletizing device 100 according to the invention with a depositing table 1 according to the invention are illustrated in FIG. 2, whereby the depositing table or the depositing device 2, respectively, is illustrated in the open position 6 in the left illustration, and whereby the closed position 5 of the depositing device 2 is illustrated purely schematically in the right image.

A pallet with sacks 201 stacked thereon or with stacked piece goods, respectively, can be seen next to the palletizing device 100, whereby it can be seen here that in the exemplary embodiment shown here, the uppermost sack layer 200 has a layer pattern, in which two sacks are aligned longitudinally and three sacks are aligned transversely. The sack layer 200 is accordingly oriented the other way round therebelow, in order to provide for a particularly stable stacking of sacks.

During the palletizing of the sacks 201, a sack layer 200 is initially formed on the depositing table 1 or on the depositing device 2, respectively. When the sack layer 200 is formed, the depositing device 2 is displaced into the closed position 5, in which it is located above a pallet, onto which the sacks 201 are to be pushed off later.

If the sack layer 200 is in the correct position, the depositing device 2 is pulled away, whereby the sack layer 200 is pushed off onto a pallet located therebelow or onto a sack layer 200, which is already arranged on the pallet, respectively.

A depositing table 1 according to the invention is illustrated purely schematically in a perspective view in FIG. 3. It can be seen here that the depositing table 1 has a depositing device 2, which has a depositing surface 8, on which sacks 201 can be arranged to form a sack layer 200.

The depositing device 2 is thereby formed in a hollow manner or so that air can flow through it, respectively, at least in sections, so that air can be blown out via air discharging openings 11 in the upper side 7 of the depositing device 2 or of the depositing surface 8, respectively, whereby a type of air cushion is created below the sack layer 200, which simplifies the push-off onto a pallet below the depositing table 1 or of the depositing device 2, respectively.

In order to supply air to the depositing device 2 or the air discharging openings 11, respectively, the depositing table 1 comprises, according to the invention, an air feeding device 4. In the exemplary embodiment shown here, the air feeding device 4 has an air guiding element 12, which comprises an air inlet 17, which is connected to a blower device 16 here.

The airflow provided by the blower device 16 is fed here to the air inlet 17 of the air guiding element 12 via a pipe, the airflow is further guided via the air guiding element 12 to an air blow-out opening 13, which is in contact with the connecting device 14. The connecting device 14 is provided by means of pipes 20 here, which engage with one another in a telescopic manner. The length of the connecting device 14 can be changed or it can be telescoped, respectively, by means of such a pipe-in-pipe system 19.

The connecting device 14 is rotatably connected with one side to the air outlet opening 13 of the air guiding element 12 by means of a pneumatic rotary feedthrough 15. A rotatable connection, here also formed as pneumatic rotary feedthrough 15, which is connected to the air feeding opening 10 on the lower side 9 of the depositing device 2, is also provided on the other side.

The depositing table 1 shown in FIG. 3 is illustrated in FIG. 4, whereby the depositing surface 8 is not illustrated here, so that the interior of the depositing device 2 and thus also the air feeding opening 10 of the depositing device 2 is visible.

The depositing table according to the invention according to the previously shown figures is illustrated in a sectional view from the side in FIG. 5. In the exemplary embodiment shown here, the depositing device 2 is present in the open position 6, in which the depositing device 2 is at least partly present between the upper run 103 and the lower run 104 of the conveying element 102 of the conveying device 101 of the palletizing device 100.

This is a significant advantage of the present invention because a configuration with a particularly flat construction becomes possible due to the specific configuration of the air feeding device 4, so that the depositing device 2 can be displaced without a risk of collision with the conveying element 102 of the conveying device 101.

This results, for example, from the fact that the connecting device 14 is provided as flat as possible under the depositing device 2 in a plane parallel to the depositing device 2. Due to the fact that the connecting device is held or arranged, respectively, independently of the position of the depositing device 2 in this plane, the installation is possible in an assembly space, which is as small as possible. The depositing device 2 can in particular also be moved with the connecting device 14 between upper run 103 and lower run 104.

An exemplary embodiment of a depositing table according to the invention is illustrated once in the open position 6 and once in the middle position 21 in FIGS. 6 and 7. The completely closed position 5 of this exemplary embodiment has already been shown in FIG. 3.

An exemplary embodiment of a depositing table 1 according to the invention without depositing device 2 is illustrated purely schematically in FIGS. 8 to 10. It can be seen here that the displaceability or movability, respectively, of the depositing device 2 is attained by means of a displacing device 3, which is provided by means of a rail system 22 here.

The completely closed position 5 is thereby illustrated in FIG. 8, a middle position 21 is illustrated in FIG. 9 and the completely open position 6 is illustrated in FIG. 10.

It can be seen in these illustrations that the connection of the air feeding device 4 to the depositing device 2 is made possible by means of a telescopable connecting device 14. A rigid or stationary air guiding element 12, respectively, is thereby provided here, to which the connecting device 14 is connected.

It is thereby provided here that a minimally extended or telescoped pipe-in-pipe system 19, respectively, is provided when the depositing device 2 is present in the middle position 21. It thus becomes possible that the connecting device 14 or the pipe-in-pipe system 19, respectively, is lengthened to the two end layers, namely the open position 6 and the closed position 5. The connecting device 14 in the middle position 21 is thus present approximately transversely to the moving direction 18.

By providing a pipe-in-pipe system 19 with a connection, which is formed essentially in a rigid manner, it becomes possible to provide for a connection, which has a particularly flat construction, of the air feeding device 2 to the depositing device 2. It can also be attained hereby that the depositing device 2 can be moved between upper run 103 and lower run 104 of the conveying element 102 or of the conveying device 101, respectively, without having to fear a collision, as it would or could otherwise occur, respectively, when using air hoses when using a so-called monkey swing.

The open position 6, the middle position 21 and the closed position 5 of the depositing device 2 are once again illustrated from the bottom in FIGS. 11 to 13. The different deflections of the telescopable connecting device 14 can also be seen here.

Depending on the configuration, a pipe-in-pipe system 19 consisting of at least two pipes 20 can be used as connecting line 14 in the exemplary embodiment shown here. A specific sealing of this system is not necessary and is also not wanted, depending on the configuration. It can thus be attained, for example by means of a certain leakage, that dust penetrating into the connecting device 14 is blown out again. An absolutely tight system is additionally not necessary because no particularly large pressures for creating the air cushion below the sack layer 200 are necessary. The airflow between the pipe parts in particular forms a wear-reducing air cushion during the movement.

Depending on the configuration, a different type of connecting device 14 can also be provided. In addition to a pipe-in-pipe system 19, a type of bellows can also be used, for example, or hoses can also be used, for example, which are held in a, e.g., v-shaped support structure, which can be moved in a corresponding plane.

### REFERENCE NUMERALS

1 depositing table
2 depositing device
3 displacing device
4 air feeding device
5 closed position
6 open position
7 upper side
8 depositing surface
9 lower side
10 air feeding opening
11 air discharging opening
12 air guiding element
13 air outlet opening
14 connecting device
15 pneumatic rotary feedthrough
16 blower device
17 air inlet
18 moving direction
19 pipe-in-pipe system
20 pipe
21 middle position
22 rail system
100 palletizing device
101 conveying device
102 conveying element
103 upper run
104 lower run
105 sack infeed
106 smoothing device
107 gripping and rotating device
200 sack layer
201 sack
300 piece goods
400 packaging facility

1. A depositing table, in particular for a palletizing device for palletizing sacks, comprising: at least one depositing device, at least one displacing device and at least one air feeding device;
wherein the depositing device is formed such that it can be moved by means of the displacing device at least between a closed position and an open position;
wherein an upper side of the depositing device comprises at least one depositing surface for receiving at least one sack layer;
wherein the depositing device is formed such that it can be flown through by air at least in sections;
and wherein at least one air feeding opening is provided on a lower side of the depositing device;
wherein the depositing surface has at least one air discharging opening, and wherein the air feeding device comprises at least one air guiding element with at least one air outlet opening and at least one connecting device, wherein the connecting device is arranged between the air outlet opening of the air guiding element and the air feeding opening of the depositing device; and
the connecting device is suitable and formed to effect an essentially coplanar length compensation between the air outlet opening and the air feeding opening when the depositing device is moved.

2. The depositing table according to claim 1, wherein the connecting device is formed in a telescopable manner at least in sections.

3. The depositing table according to claim 1, wherein the air guiding element is stationary.

4. The depositing table according to claim 1, wherein the connecting device is present in a parallel plane to the depositing device.

5. The depositing table according to claim 1, wherein the connecting device is rotatably connected to the air blow-out opening of the air inlet element and/or of the air feeding opening of the depositing device, in each case by means of at least one pneumatic rotary feedthrough.

6. The depositing table according to claim 1, wherein the connecting device is arranged transversely to the moving direction of the depositing device.

7. The depositing table according to claim 1, wherein the air outlet opening of the air guiding element is spaced apart equally from the air feeding opening in the closed position and the open position of the depositing device.

8. The depositing table according to claim 1, wherein the connecting device has a maximum extension when the depositing device is present in the closed position and/or the open position.

9. The depositing table according to claim 1, wherein the connecting device has a minimum extension when the depositing device is present between the closed position and the open position.

10. The depositing table according to claim 1, wherein the connecting device comprises at least one pipe-in-pipe system.

11. The depositing table according to claim 1, wherein the pipes of the pipe-in-pipe system are not connected to one another in a fluid-tight manner.

12. The depositing table according to claim 1, wherein the connecting device comprises at least one bellows.

13. The depositing table according to claim 1, wherein the connecting device comprises at least one carrier device, which is connected in an articulated manner.

14. The depositing table according to claim 1, wherein at least one blower device is connected to at least one air inlet of the air guiding element.

15. A palletizing device for palletizing piece goods, comprising at least one conveying device with at least one conveying element for conveying piece goods and at least one depositing table according to claim 1.

16. The palletizing device according to claim 15, wherein the depositing device of the depositing table is displaceable at least in sections between upper run and lower run of the at least one conveying element.

17. The palletizing device according to claim 15, wherein the connecting device is arranged at least in sections between the upper run and the lower run in a plane parallel to the upper run and/or the lower run.

18. The palletizing device according to claim 15, wherein the air guiding element is arranged at least in sections between the upper run and the lower run in a plane parallel to the upper run and/or the lower run.
